(19) United States
(12) Patent Application Publication
(10) Pub. No.: US 2026/0280773 A1
(43) Pub. Date: Sep. 17, 2026

(54) FREQUENCY BUNDLED TRANSMISSION (FBT) APPROACHES FOR ULTRA-RELIABLE LOW LATENCY COMMUNICATION (URLLC) SYSTEMS

(71) Applicant: InterDigital Patent Holdings, Inc., Wilmington, DE (US)

(72) Inventors: Tariq ELKOURDI, Belleville, NJ (US); Sudhir PATTAR, Mount Laurel, NJ (US); Philip PIETRASKI, Jericho, NY (US); Joe HUANG, Montville, NJ (US); Jane MACK, Melville, NY (US); Phillip LEITHEAD, King of Prussia, PA (US); Daniel STEINBACH, Commack, NY (US)

(73) Assignee: InterDigital Patent Holdings, Inc., Wilmington, DE (US)

(21) Appl. No.: 19/471,220

(22) PCT Filed: Mar. 27, 2024
(86) PCT No.: PCT/US2024/021690

§ 371 Date: Sep. 30, 2025

Related U.S. Application Data
(60) Provisional application No. 63/456,294, filed on Mar. 31, 2023.

(51) Int. Cl. H04L 1/1812; H04L 1/1867; H04L 5/00

(52) U.S. Cl. CPC H04L 1/1819; H04L 1/1893; H04L 5/0044; H04L 5/0094

(57) ABSTRACT

Methods, devices, and systems for mitigating the impact of high-power narrow band interference on hybrid automatic repeat request (HARQ) performance in URLLC systems. In a first aspect, the present application is directed to implementations of frequency bundled transmissions (FBTs), which may enable a device to simultaneously or near-simultaneously transmit different individual redundancy versions (RVs) of the same uplink data of multiple pre-configured frequency resources. In a second aspect, the present application is directed to implementations of FBTs with frequency domain repetitions, which may enable a device to simultaneously or near-simultaneously transmit redundancy version bundles of the same uplink data over multiple pre-configured frequency resources.

### RELATED APPLICATIONS

The present application claims the benefit of and priority to U.S. Provisional Patent Application No. 63/456,294, filed Mar. 31, 2023, the entirety of which is incorporated by reference herein.

### BACKGROUND

Operations of cellular communication systems on shared frequency bands with other systems, such as aviation radar, may result in interference and impaired functionality of critical systems. Mitigation approaches may add transmission and processing delays, which may be unsuitable for many implementations, such as ultra-reliable low latency communication (URLLC) uses.

### SUMMARY

Described herein are implementations of systems and methods for mitigating the impact of high-power narrow band interference on hybrid automatic repeat request (HARQ) performance in URLLC systems. In a first aspect, the present application is directed to implementations of frequency bundled transmissions (FBTs), which may enable a device to simultaneously or near-simultaneously transmit different individual redundancy versions (RVs) of the same uplink data of multiple pre-configured frequency resources. In a second aspect, the present application is directed to implementations of FBTs with frequency domain repetitions, which may enable a device to simultaneously or near-simultaneously transmit redundancy version bundles of the same uplink data over multiple pre-configured frequency resources.

Implementations of these solutions may significantly reduce latency for URLLC applications, including “one-shot” decoding. In one-shot decoding, a number of redundancy versions are decoded correctly in a single time instance to allow for correct decoding of original transmitted data. FBT implementations may be advantageous for use cases requiring increased reliability while maintaining bandwidth to support multiple users (e.g., transportation applications). FBT with Frequency Domain Repetitions implementations may be advantageous for use cases requiring maximum reliability with no major constraint on bandwidth (e.g., remote surgery) as this approach may possibly allow for multiple one-shot decoding chances in each transmission instance.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment; and

FIG. 1D is a system diagram illustrating a further example RAN and a further example CN that may be used within the communications system illustrated in FIG. 1A according to an embodiment;

FIG. 2A is a diagram of an embodiment of time domain resource allocation, according to some implementations;

FIG. 2B is a diagram of an embodiment of time domain resource allocation with slot aggregation enabled;

FIG. 2C is a diagram of an embodiment of time domain resource allocation with slot aggregation disabled;

FIG. 2D is a table showing an implementation of downlink control information (DCI) format vs. resource allocation type;

FIG. 2E is a diagram of an example of frequency domain resource allocation type 0, according to some implementations;

FIG. 2F is a diagram of an example of frequency domain resource allocation type 2, according to some implementations;

FIG. 3A is an illustration of an example of frequency bundled transmissions over a plurality of resource block groups, according to some implementations;

FIG. 3B is an illustration of another example of frequency bundled transmissions over a plurality of resource block groups, according to some implementations;

FIG. 3C is an example table of redundancy versions for various transmission occasions and frequency resources, according to some implementations of frequency bundled transmissions over a plurality of resource block groups;

FIG. 3D is an illustration of frequency bundled transmissions with frequency wrap-around, according to some implementations;

FIG. 3E is an illustration of an example of frequency bundled transmissions with frequency domain repetitions, according to some implementations;

FIG. 3F is an illustration of an example of frequency bundled transmissions with frequency domain repetitions and a frequency shift, according to some implementations; and

FIG. 4 is a flow chart of a method for frequency bundled transmissions, according to some implementations.

### DETAILED DESCRIPTION

With the capability of recent cellular communication systems to operate on new shared frequency bands, the interference between these systems and other non-cooperative systems such as aviation radars has become a major concern. To alleviate these and other issues, dynamic spectrum sharing techniques may be used to enable radars and cellular systems to coexist. Radar signal characteristics such as high transmitter peak power, narrow frequency bands, and periodicity, along with the sensitive design of radar receivers may be important considerations. Moreover, interference from the radar could potentially degrade the performance of modern commercial wireless systems which rely on lower latency and higher throughputs. This issue is particularly critical for delay sensitive use cases such as ultra-reliable low latency communications (URLLC) for which conventional interference mitigation approaches are not suitable. For instance, feedback for uplink (UL) transmissions on a physical uplink shared channel (PUSCH) may be carried on a subsequent UL grant, which entails added transmission and processing delays.

Such mechanisms do not meet the latency requirements for URLLC. PUSCH slot aggregation may be used to enable a wireless transmit receive unit (WTRU), user equipment (UE) or other devices to transmit the same transport block over a preconfigured number of consecutive slots without waiting for hybrid automatic repeat request (HARQ) feedback. While this may help reduce the latency, it may be insufficient as retransmissions still happen sequentially in time. For instance, if the interfering transmission is longer than the allocated slots (or has a periodicity that partially or fully overlaps with the retransmissions), all transmissions may fail. This issue may be critical especially for URLLC as transmissions may occur in the sub-slot level.

Accordingly, the present disclosure is directed to systems and methods for mitigating the impact of high-power narrow band interference on HARQ performance in URLLC. A base station or other device may detect the presence of an interferer and inform WTRU or other devices to transmit different redundancy versions of the same uplink data simultaneously over multiple frequency resources. In a first aspect, the present disclosure is directed to implementations of Frequency Bundled Transmissions (FBT), which enable the WTRU or other devices to simultaneously transmit different individual redundancy versions (RVs) of the same uplink data over multiple pre-configured frequency resources. Unlike PUSCH slot aggregation which allows the base station to signal the time separation between different RVs to the WTRU, implementations of FBT allow the base station or other device to signal a frequency separation between different simultaneous RVs to the WTRU. A pre-configured frequency shift and time shift between transmission instances can be applied to maximize data transmission reliability and minimize latency. Frequency wrap-around may be implemented to allow FBT implementations to operate at the lower edge of the available band.

In a second aspect, the present disclosure is directed to implementations of FBT with Frequency Domain Repetitions, which enable the WTRU or other devices to simultaneously transmit redundancy version (RV) bundles (e.g., {RV2, RV3, RV1, RV0}) of the same uplink data over multiple pre-configured frequency resources. The base station or other device may signal a frequency separation between simultaneous RV bundles to the WTRU via a parameter such as the J2 offset parameter. A pre-configured frequency shift and time shift between transmission instances can be applied to maximize data transmission reliability and minimize latency. Frequency wrap-around may be implemented to allow FBT implementations to operate at the lower edge of the available band.

In some implementations, the WTRU or other devices may inform the network if it supports FBT and/or FBT with frequency domain repetitions as part of its WTRU capability message. The network may optionally enable or disable these features for the WTRU via radio resource control (RRC) signaling based on the WTRU capability and the network's requirement. If the WTRU indicates that it does not support these solutions, in some implementations, the network may use legacy behavior for all PUSCH transmissions as described in the 3GPP TS 38.214 version 17.1.0 document, which is incorporated by reference herein.

Implementations of these systems and methods may significantly reduce latency for URLLC applications using “one-shot” decoding. In one-shot decoding, enough redundancy versions are decoded correctly in a single time instance to allow for correct decoding of original transmitted data. Implementations of FBT may be a suitable solution for use cases requiring increased reliability while maintaining bandwidth to support multiple users (e.g., transportation applications). Implementations of FBT with Frequency Domain Repetitions may be beneficial for use cases requiring maximum reliability with no major constraints on bandwidth (e.g., remote surgery) as this approach may possibly allow for multiple one-shot decoding chances in each transmission instance.

For reference, various abbreviations and acronyms are used herein, e.g., as follows:
3GPP Third Generation Partnership Project
5G 5th Generation
ACK Acknowledgement
BWP Bandwidth Part
CG Configured Grant or Cell Group
CP Cyclic Prefix
CRC Cyclic Redundancy Check
DCI Downlink Control Information
DL Downlink
DM-RS Demodulation Reference Signal
eMBB enhanced Mobile Broadband
FBT Frequency Bundled Transmission
gNB NR NodeB
HARQ Hybrid Automatic Repeat Request
IM Interference Measurement
LTE Long Term Evolution e.g. from 3GPP LTE R8 and up
MAC Medium Access Control
MCS Modulation and Coding Scheme
MIB Master information block
MIMO Multiple Input Multiple Output
NACK Negative ACK
NAS Non-access stratum
NR New Radio
OFDM Orthogonal Frequency-Division Multiplexing
PDCCH Physical Downlink Control Channel
PDU Packet Data Unit
PHY Physical Layer
PO Paging Occasion
PUCCH Physical Uplink Control Channel
PUSCH Physical Uplink Shared Channel
RA Random Access (or Random Access procedure)
RACH Random Access Channel
RADAR Radio Direction and Ranging
RAR Random Access Response
RB Resource Block
RBG Resource Block Group
RE Resource Element
RF Radio Front end
RNTI Radio Network Identifier
RNA RAN Notification Area
RO RACH occasion
RRC Radio Resource Control
RS Reference Signal
RV Redundancy Version
SCS Subcarrier Spacing
SIB System Information Block (e.g. SIB1, SIB2, etc.)
TB Transport Block
TTI Transmission Time Interval
UE User Equipment
UL Uplink
URLLC Ultra-Reliable and Low Latency Communications
WLAN Wireless Local Area Networks and related technologies (IEEE 802.1 domain)
WTRU Wireless Transmit Receive Unit

Prior to discussing implementations and embodiments of the systems and methods discussed herein, in may be helpful to briefly discuss embodiments of communications systems and devices which may be used with these systems and methods.

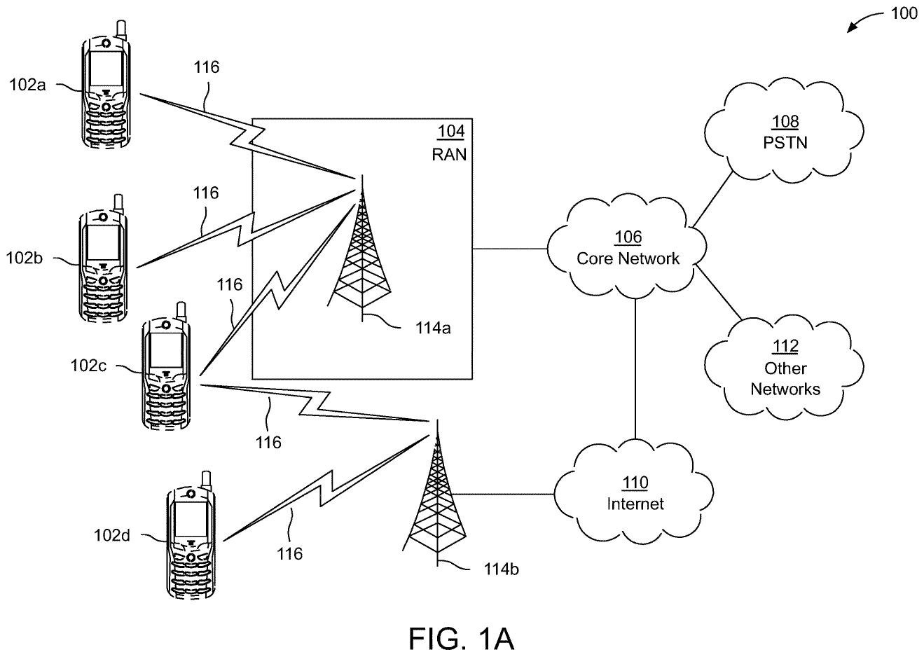

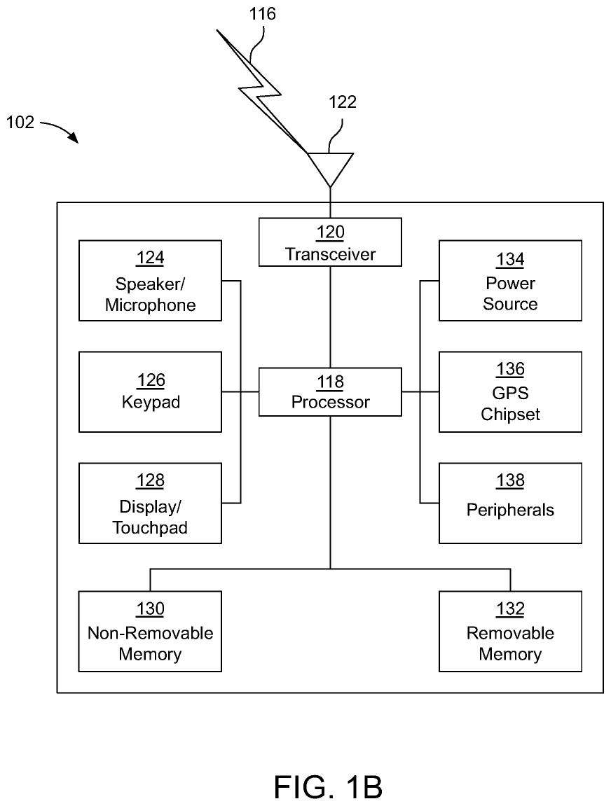

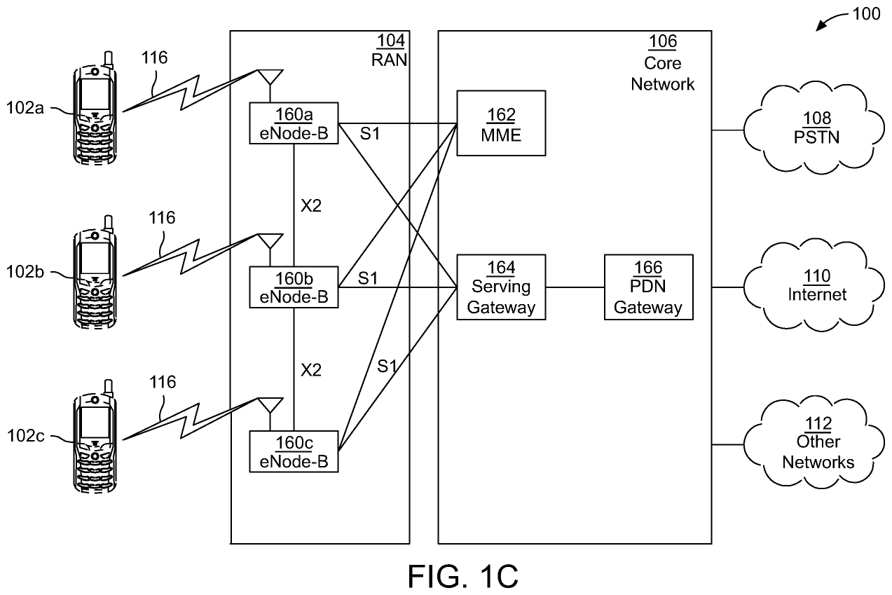

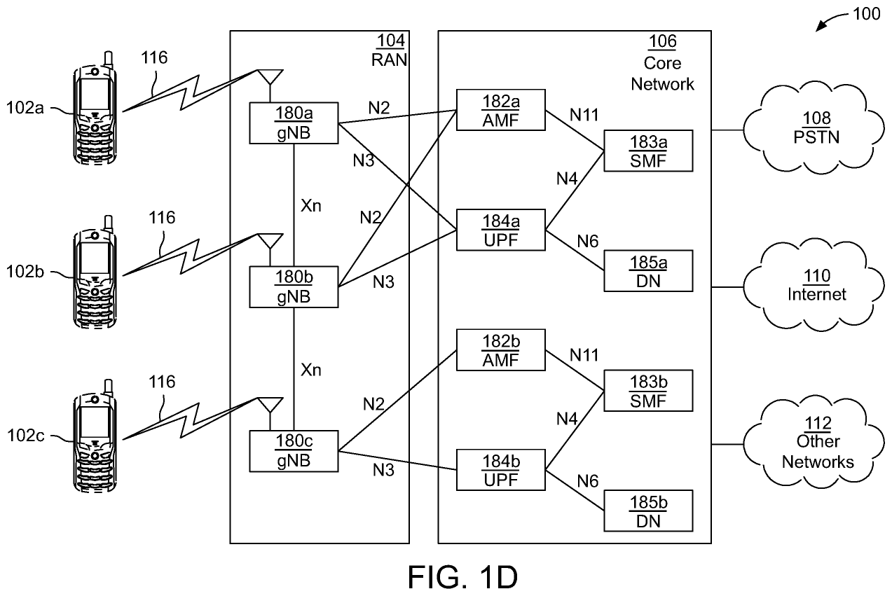

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 3×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of awired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Before discussing specific details of implementations of the solutions, it may be helpful to briefly discuss implementations of URLLC systems, and time-domain and frequency-domain resource allocation methods using a physical uplink shared channel (PUSCH). Unlike LTE which uses slot-based transmissions (mapping type A) in which transmissions can only start at the beginning of the slot, 5G uses sub-slot-based transmissions (mapping type B), which facilitates services with low latency requirements. In 5G, packets may be scheduled in more transmission opportunities within a single slot as compared to LTE. Moreover, a gNB has the capability to puncture DL eMBB resources to schedule URLLC transmissions as soon as possible.

Additionally, uplink configured grants (CGs) may be utilized to support uplink low latency transmissions. Configured grant resources are indicated to the WTRU by the gNB and are used for PUSCH transmissions without the need for a Scheduling Request or an explicit grant. In many implementations, two types of UL CG may be utilized, Type 1 and Type 2. In Type 1, RRC signaling is used to configure the time and frequency resources and all other related parameters such as periodicity and repetitions. In Type 2, only periodicity and the number of repetitions are configured via RRC signaling, and the remaining parameters may be sent via DCI.

URLLC use cases may include AR/VR, smart grids, automation, and transport industry and electrical power distribution, among others. Many of these use cases require higher reliability and lower latency in both uplink and downlink transmissions than for less crucial communications. For instance, in DL transmissions, enhancements such as PDCCH monitoring capability and new DCI formats may be utilized to increase reliability and reduce latency. Additional enhancements may include URLLC support in unlicensed spectrum portions, improved physical layer feedback, and intra-device multiplexing and prioritization.

In many implementations, for data transmission and reception to occur, the network may need to inform the WTRU about which slots/symbols may be utilized for transmission and reception of data. This resource allocation signaling may occur either dynamically or in a semi-persistent manner, depending on implementation.

In uplink dynamic scheduling, resource allocation information is conveyed via PDCCH DCI. In 5G NR, DCI formats 0_0 and 0_1 are used for dynamic PUSCH time-domain resource allocation. These formats carry 4-bit ‘time domain resource assignment’ which points to one of the rows of a look-up table (e.g. up to 16 rows, in some implementations) where each row provides the following parameters:
slots offset K2 used to indicate the offset to the slot for PUSCH transmission;
SLIV (jointly coded Start and Length Indicator Values), used to derive values for the start symbol ‘S’ and the allocation length ‘L’; and
‘PUSCH mapping type’ to be applied on the PUSCH transmission, Type A or Type B, which determines the first DM-RS symbol position.

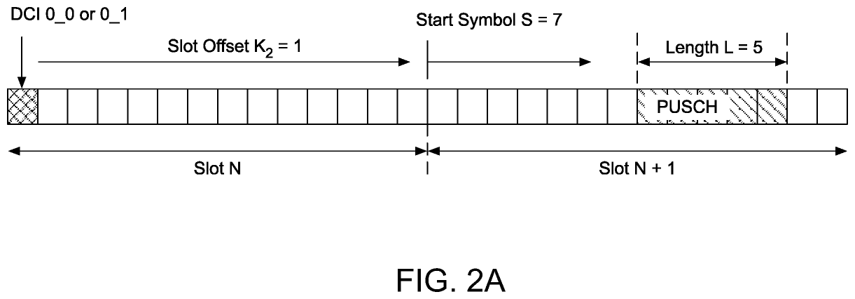

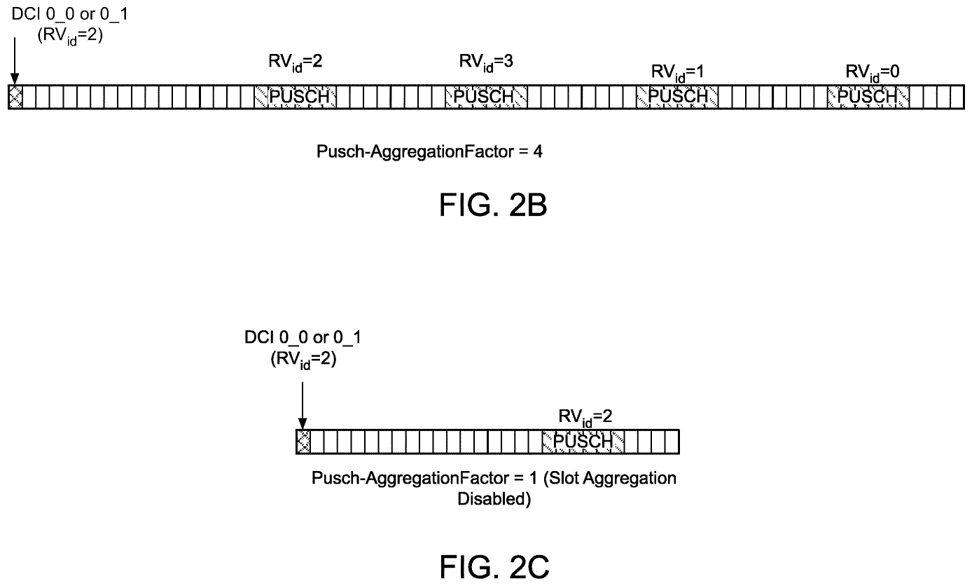

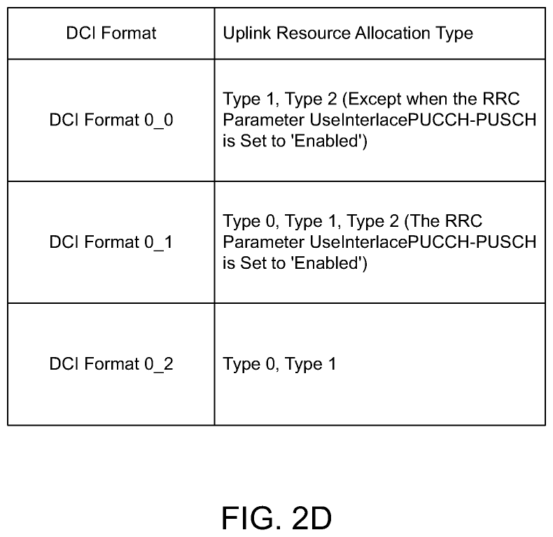

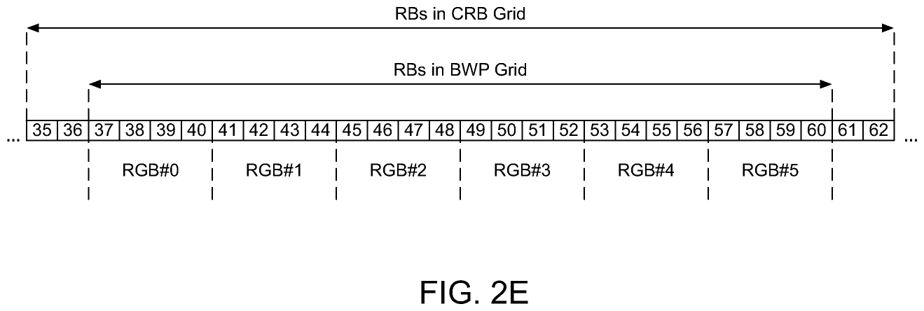

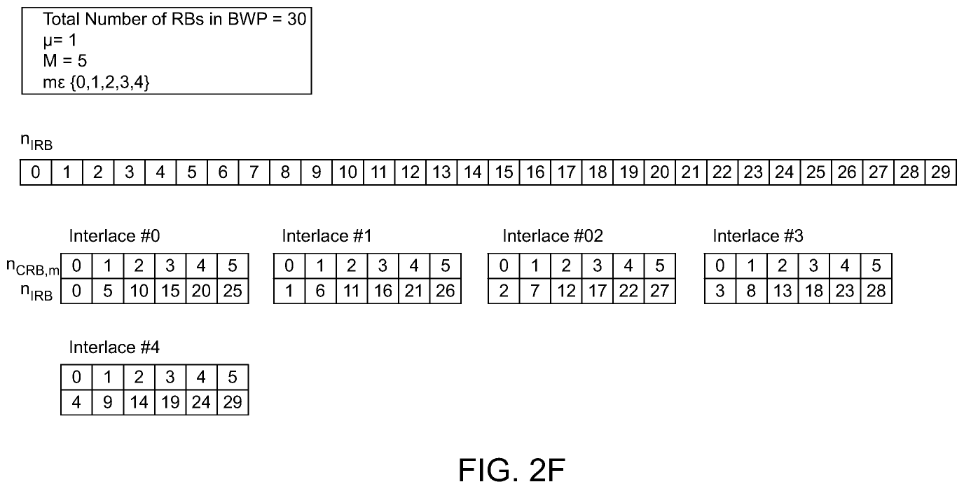

FIG. 2A is a diagram of an embodiment of time domain resource allocation, and illustrates an example with allocation set as K2=1 slot, S=7 symbols, and L=5 symbols. In many implementations, every time-domain resource allocation must be contained within a single slot—that is, an allocation must not span multiple slots. Cyclic prefix (CP) may play a factor in determining the number of allocated symbols. With a normal CP, a slot may contain 14 symbols; with an extended CP, a slot may contain 12 symbols. Hence, ‘S+L’ should not exceed these limits for the corresponding CP.

There are two types of PUSCH resource allocation tables:
a “default PUSCH time domain allocation table A”; and
an RRC configured table PUSCH-TimeDomainAllocationList conveyed by either PUSCH-ConfigCommon or PUSCH-Config.

The WTRU may choose an appropriate table. An additional slot delay value defined for the first transmission of PUSCH scheduled by the RAR grant that increases with SCS may also be utilized.

The IE PUSCH-TimeDomainResourceAllocation is used to determine a time domain offset between PDCCH and PUSCH. PUSCH-TimeDomainResourceAllocationList may list up to 64 PUSCH-TimeDomainResourceAllocations in many implementations. The WTRU determines the bit width of the DCI field based on the number of entries in the PUSCH-TimeDomainResourceAllocationList. The DCI will indicate which of the configured time domain allocations the WTRU must use for that UL grant.

PUSCH-TimeDomainResourceAllocationList IE contains K₂, PUSCH mapping type, and startSymbolAndLength (SLIV). The value of K₂=0 allows for PUSCH transmission within the same slot where the grant is received (i.e., self-contained slot). When K₂ field is absent, in many implementations, the WTRU applies:
the value 1 when PUSCH SCS is 15/30 kHz;
the value 2 when PUSCH SCS is 60 kHz, and
the value 3 when PUSCH SCS is 120 KHz.
   Other values may be utilized in other implementations.

Parameter startSymbolAndLength provides an index indicating valid combinations of start symbol and length (jointly encoded) as start and length indicator (SLIV). The ‘S’ and ‘L’ values allocated for the PUSCH are determined from the SLIV as shown below:

```
if (L − 1) ≤ 7:
  SLlV = 14.(L − 1) + S
else:
  SLlV = 14·(14 − L + 1) + (14 − 1 − S)
where 0 < L ≤ 14 − S
```

Parameter mappingType defines the DM-RS configuration of PUSCH transmissions as follows: type A and type B.

In some implementations using PUSCH mapping type A, DM-RS is mapped relative to the start of the slot if frequency hopping is disabled and relative to start of each hop in case if frequency hopping is enabled. The position of the first DM-RS symbol for type A is configured by RRC via either MIB or via ServingCellConfigCommon (SIB1 or dedicated signaling). The field dmrs-TypeA-Position indicates two values pos2 or pos3 (i.e., first DMRS symbol is at symbol 2 or at symbol 3 within the slot).

In some implementations using PUSCH mapping type B, DM-RS is mapped relative to the start of the PUSCH allocation. (DM-RS symbol is the first symbol where PUSCH transmission starts if frequency hopping is disabled and relative to the start of each hop in case frequency hopping is enabled).

For uplink Semi-Persistent Scheduling, DCI 0_0 and DCI 0_1 are addressed to Configured Scheduling-RNTI (CS-RNTI). The grant received using CS-RNTI is referred to as configured grant. A configured grant is given by the network to the WTRU which uses it according to the pre-configured timing given by the network. There are two types of configured grants: Type 1 and Type 2.

Time-domain resource allocation for configured grant type 1 is carried out via RRC. PDCCH DCI 0_0 or 0_1 addressed to CS-RNTI is used only for re-transmissions. Once the network configures time-domain resource using RRC, the only way to change the allocation is by sending RRCReconfiguration message to the WTRU.

Time-domain resource allocation in configured grant type 2 is done using PDCCH DCI 0_0 or 0_1 addressed to CS-RNTI (even for re-transmissions). Once configured using DCI 0_0 or 0_1, the WTRU periodically uses same time-domain resources until the configured grant is de-activated.

In slot aggregation, the WTRU does not wait for feedback from the gNB, but rather it retransmits PUSCH in consecutive slots (i.e., transmits the same TB over multiple consecutive slots). This is beneficial in cell edge scenarios in which re-transmissions are more probable. The set of all retransmissions of the same TB is called a bundle. The same HARQ process is used for each transmission within a bundle. For each bundle, HARQ retransmissions are triggered without waiting for feedback from previous transmission.

In many implementations, slot aggregation is configured via RRC signaling using the following parameters.
PUSCH-AggregationFactor within PUSCH-Config IE is used for the case of dynamic scheduling. This field can take values of 2, 4 or 8 repetitions as shown below. When the field is absent the WTRU applies the value 1. PUSCH-AggregationFactor may be enumerated as {n2, n4, n8}
repK within ConfiguredGrantConfig IE for the case of configured grant. This field may take values of 1, 2, 4, and 8. Slot aggregation is activated when repK>1. repK may be enumerated as {n1, n2, n4, n8}

The network sends DCI format 0_1 on PDCCH with CRC scrambled with C-RNTI or MCS-C-RNTI for dynamic grant and CS-RNTI with NDI=1 for configured grant.

The WTRU follows the below procedure considering PUSCH-AggregationFactor is applicable for dynamic scheduling and repK is applicable for configured uplink grant:
When the MAC entity is configured with PUSCH-AggregationFactor>1 or repK>1, the parameter PUSCH-AggregationFactor/repK provides the number of transmissions of the same TB within a bundle.
After the initial transmission, PUSCH-AggregationFactor−1 or repK−1 HARQ retransmissions follow within a bundle.
The same HARQ process is used for each transmission that is part of the same bundle.
The WTRU may repeat the TB across the PUSCH-AggregationFactor/repK consecutive slots applying the same symbol allocation in each slot.
PUSCH repetition Type B may be used to eliminate time gap among repetitions and because the repetitions are carried out in the consecutive sub-slots so one slot might contain more than one repetition of a transport block.
For dynamic scheduling, the redundancy version to be applied on the nth transmission occasion of the TB, where n=0, 1, . . . (PUSCH-AggregationFactor−1), may be determined.
For configured grant, the parameter repK-RV (if configured within configuredGrantConfig IE) is used to derive the redundancy version pattern to be applied to the repetitions. If this parameter repK-RV is not configured, the redundancy version for uplink transmissions may be set to 0. repK-RV maybe enumerated as {s1-0231, s2-0303, s3-0000}

When slot aggregation is active, the PUSCH is limited to a single transmission layer. FIG. 2B is a diagram of an embodiment of time domain resource allocation with slot aggregation enabled, specifically showing an example of PUSCH slot aggregation for aggregation factor 4 with a RV pattern {RV2, RV3, RV1, RV0}derived for dynamic scheduling. By contrast, FIG. 2C is a diagram of an embodiment of time domain resource allocation with slot aggregation disabled.

NR supports the following resource allocation types:
Uplink resource allocation type 0 which is used for PUSCH only when transform precoding is disabled.
Uplink resource allocation scheme type 1 and type 2 which are used for PUSCH for both cases when transform precoding is enabled or disabled.

The network informs the WTRU about which resource allocation scheme to be used via RRC signaling. PUSCH-Config IE is used for dynamic resource allocations and ConfiguredGrantConfig IE is used for configured grant (semi-persistent) resource allocations. For example, PUSCH-Config IE is shown below;

```
  PUSCH-Config
  . . .
  resourceAllocation ENUMERATED {resourceAllocationType0, resourceAllocationType1,
dynamicSwitch}
  resourceAllocationForDCI-Format0-2-r16 ENUMERATED {resourceAllocationType0,
resourceAllocationType1, dynamicSwitch}
  . . .
```

The field resourceAllocation refers to resource allocation using DCI format 0_1 and the field resourceAllocationForDCI-Format0-2 refers to DCI format 0_2. The value of these two fields should be interpreted as follows:
resourceAllocationType0→resource allocation type 0 should be used.
resourceAllocationType1→resource allocation type 1 should be used.
dynamicSwitch→resource allocation type is left flexible, meaning that either type 0 or type 1 shall be used as indicated by DCI. The MSB bit of the field ‘Frequency domain resource assignment’ within the DCI 0_1/0_2 is used to indicate resource allocation type 0 or type 1 (bit value=0→type 0 and bit value=1→type 1).

A summary of DCI format vs. resource allocation type is illustrated in the table of FIG. 2D.

For type 0 uplink resource allocations, the network can ask the WTRU to use type 0 either via RRC signaling (resourceAllocationType0) or via DCI format 0_1/0_2 (dynamicSwitch). Uplink resource allocation type 0 may comprise a bitmap-based resource allocation scheme. The RB assignment information includes a bitmap indicating the Resource Block Groups (RBGs) that are allocated to the scheduled WTRU. An RBG is a set of consecutive Virtual Resource Blocks (VRBs). In type 0, non-interleaved VRB-to-PRB mapping is performed (i.e., VRBn is directly mapped to PRBn).

The number of RBs within an RBG are derived based on the RRC parameter rbg-size configured by PUSCH-Config and the size of the bandwidth part.

The parameter rbg-Size controls the selection between configuration 1 and configuration 2 for RBG size for PUSCH. If this IE is present, then configuration 2 should be used, otherwise, configuration 1 should be used. This filed is only applicable for uplink resource allocation type 0:

PUSCH-Config
. . .
rbg-Size ENUMERATED {config2}
. . .

The bitmap is of size N_{RBG} bits with each bit within the bitmap represents an RBG and RBG #0 to RBG #N_{RBG}−1 are mapped from MSB to LSB of the bitmap.

The field Frequency domain resource assignment within DCI 0_1/0_2 is used to indicate which RBGs are allocated to the WTRU. An RBG is allocated to the WTRU if the corresponding bit value in the bitmap is 1, the RBG is not allocated to the WTRU if the bit value is 0.

FIG. 2E is a diagram of an example of frequency domain resource allocation type 0, where:
Start RB of the BWP=37
BWP size=24 RBs
Rbg configuration=configuration 2
RBG size=4
Size of the first RBG=4
Size of the last RBG=4
Size of all other RBG=4

In type 1 uplink resource allocations, the network provides the WTRU with an encoded value of starting resource block number and length of RBs. It supports contiguous allocation of resource blocks only. With type 1, the number of bits required to represent a set of RBs is less than that of type 0. As type 1 takes less bits as compared to type 0, fallback DCI format 0_0 uses type 1. For fallback DCI formats, reduced overhead is desirable as compared to scheduling flexibility as a result of non-contiguous RB allocation. The network can allocate resources for type 1 via ‘Frequency domain resource assignment’ field within DCI formats 0_0, 0_1 and 0_2.

In general, an uplink type 1 resource allocation field consists of a resource indication value (RIV) corresponding to a starting virtual resource block (RBₛₜₐᵣₜ) and a length in terms of contiguously allocated RBs (LRBs).

For type 2 uplink resource allocations, multiple interlaces of RBs are defined where an interlace m ∈{0, 1, . . . , M−1} consists of common RBs {m, M+m, 2M+m, 3M+m, . . . }, with M being the number of interlaces. The interpretation of the field ‘Frequency domain resource assignment’ within DCI format 01 depends upon whether useInterlacePUCCH-PUSCH-r16 is configured within BWP-UplinkDedicated or not. If it is configured, the WTRU uses uplink frequency domain resource allocation Type 2 for PUSCH. FIG. 2F is a diagram of an example of frequency domain resource allocation type 2, according to some implementations.

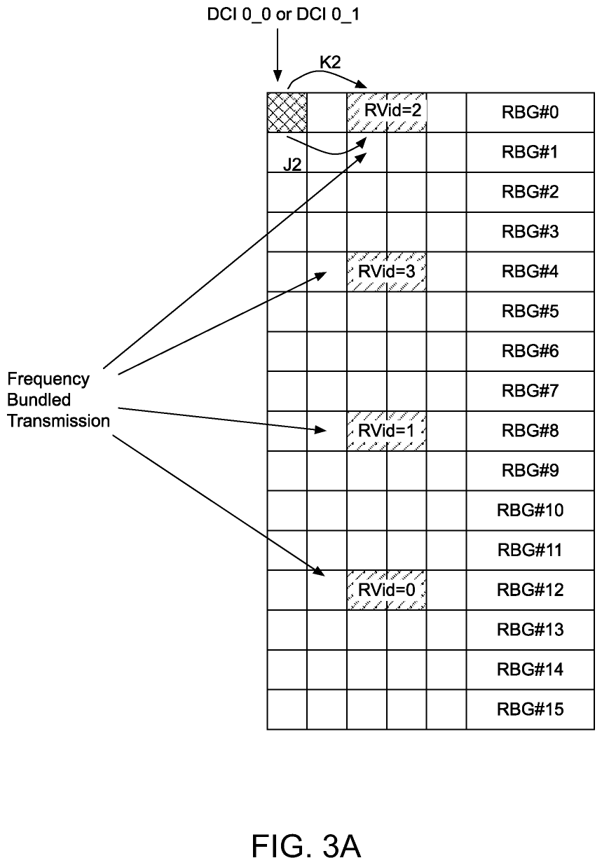

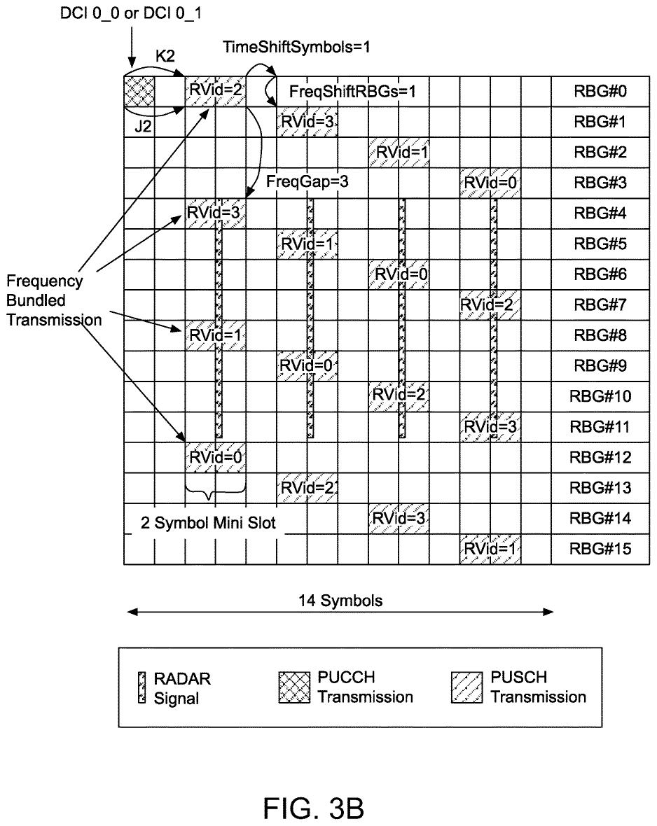

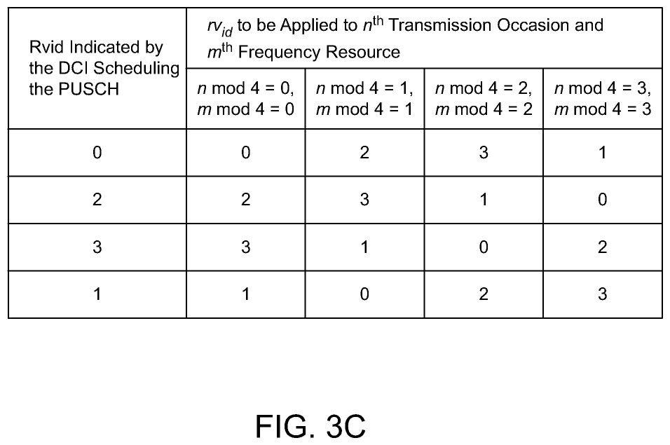

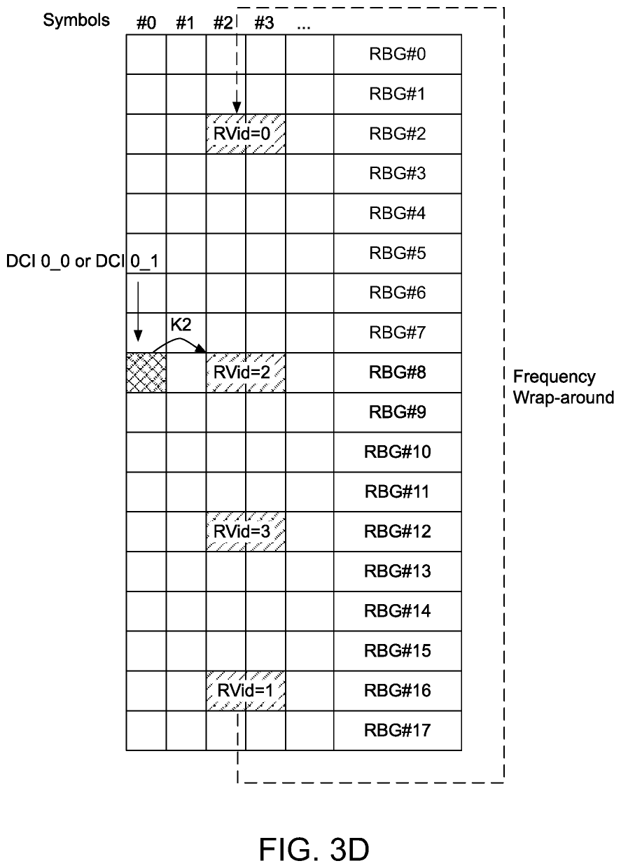

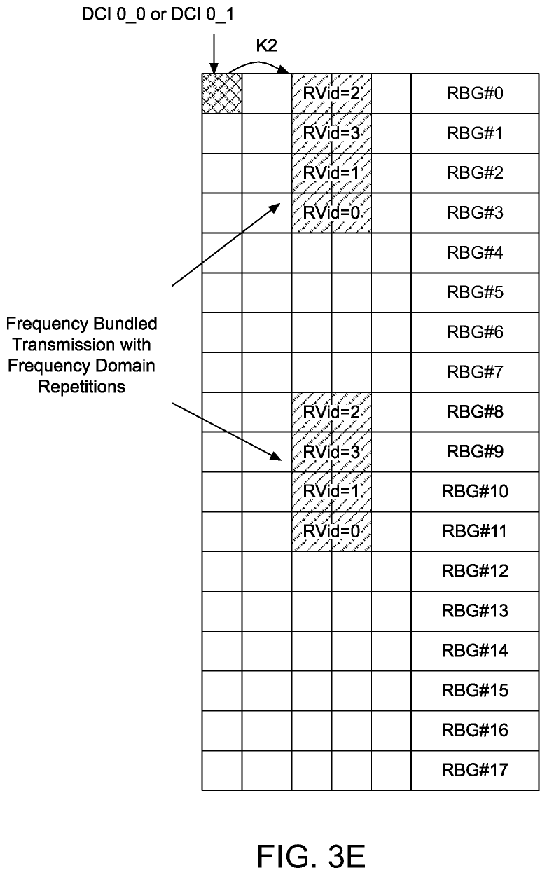

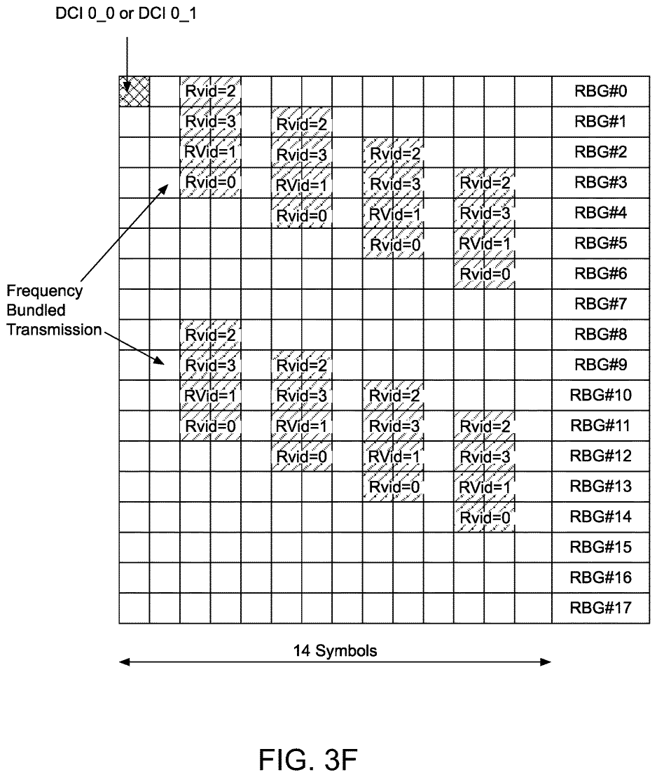

Frequency bundled transmissions mitigate the impact of periodic narrow band interference by allowing the WTRU to simultaneously transmit different redundancy versions of the same uplink data over multiple pre-configured frequency resources as illustrated in FIG. 3A, which illustrates an example of a PDCCH occasion where DCI 0_0 or DCI 0_1 schedules UL data after K2 symbols and J2 RBG offsets (with K2=1 and J2=0 in the example illustrated). At the allocated symbol/RBG, frequency bundled transmissions are transmitted simultaneously over different frequency resources.

FIG. 3B shows another example of UL data transmitted over 4 consecutive mini slots in a slot aggregation fashion and 4 consecutive RBGs in Frequency Bundled Transmission fashion (with K2=1 and J2=0, timeShiftSymbols=1, freqShiftRBGs=1, and FreqGap=3 in the example illustrated). The figure also illustrates a radar signal (shown with diagonal striping) that has a duration less than a symbol in time and 8 RBGs in frequency. The signal repeats periodically every 3 symbols. Here, FBT paired with PUSCH slot aggregation and shifts in time and frequency, may potentially help convey all 4 RVs in 3 transmission instances, instead of 4.

The network configures frequency bundled transmission via RRC signaling as follows:
PUSCH-FrequencyBundlingFactor within PUSCH-Config IE is used for the case of dynamic scheduling and is defined below
PUSCH-FrequencyBundlingFactor ENUMERATED {n1, n2, n4, n8}
repJ within ConfiguredGrantConfig IE for the case of configured grant. This field is mandatorily present and takes values of 1, 2, 4, and 8. Frequency bundling is activated when repJ>1.
repJ ENUMERATED {n1, n2, n4, n8}
timeShiftSymbols: this is used to indicate the time shift in symbols between the first transmission and subsequent retransmissions (after K2 slots). This time shift may not apply if the system cannot support it.
timeShiftSymbols {n0, n1, . . . ,n12}, where n0 means no time shift is applied (ex, URLLC applications)

For systems operating in TDD mode, a conflict between scheduling UL symbols are the slot format may not happen as both timeShiftSymbols and TDD-UL-DL-ConfigCommon (which determines the slot format) are part of RRC signaling. Additional parameters include:
freqShiftRBGs: this is used to indicate the frequency shift in RBGs between the same transmission but different time instances. This frequency shift may not apply if the system cannot support it.
freqShiftRBGs {n0, n1, . . . ,n16}, where n0 means no frequency shift is applied.
FreqGap: this defines the separation in frequency between simultaneous HARQ transmissions. In many implementations, a maximum value may be set for Type 0 allocation in FR1.

The network transmits DCI format 0_1 on with CRC scrambled with C-RNTI or MCS-C-RNTI for dynamic grant and CS-RNTI with NDI=1 for configured grant. In PDCCH (DCI) for uplink scheduling, the following parameter is received:
J2: akin to K2, this parameter indicates the offset of the first UL transmissions in unit of RBs. This offset may be configured larger than the bandwidth of the interferer to minimize the probability of erroneous reception. Since config #1 minimum rbg-Size is 2 RBs and config #2 minimum rbg-Size is 4 RBs and the largest possible carrier bandwidth is limited to 275 RBs for any SCS, J2 can be defined as follows:
J2 ENUMERATED {n0,n1, . . . , n136}, where J0 indicates that the first retransmission occurs in the same RBG as the scheduling DCI.

The WTRU follows the procedure defined below:
Parameters pusch-FrequencyBundlingFactor>1 or repJ>1 provide the number of transmissions if the same TB within a bundle.
After the initial transmission, pusch-FrequencyBundlingFactor−1 or repJ−1 retransmissions are sent within a bundle, each of which has the same HARQ process number.
The WTRU repeats UL data across the pusch-FrequencyBundlingFactor/repJ frequency sub-carriers applying the same symbol allocation in each slot/mini-slot.

For dynamic scheduling, in some implementations, the redundancy version to be applied to the n^{th} transmission occasion on the m^{th} RBG, where n=0,1, . . . , (pusch-aggregationFactor−1) and m=0,1, . . . , (pusch-FrequencyBundlingFactor−1), is determined as shown in the table of FIG. 3C, where for n<=pusch-aggregationFactor−1 and m<=pusch-FrequencyBundlingFactor−1, the (n,m)^{th} transmission uses redundancy version identifiers (rvid=) according to the table of FIG. 3C. Other enumeration or versioning methods may be utilized in other implementations.

In some implementations, if the frequency range of the FBT exceeds the supported bandwidth, frequency wrap-around may be used as illustrated in FIG. 3D. In the example in the figure, FBT is activated without PUSCH slot aggregation. A bundle of 4 transmissions {RVid=2, RVid=3, RVid=1, RVid=0} are made simultaneously on symbols 2 and 3. The first transmission starts at RBG8 with FreqGap=3 RBGs in between transmissions. To accommodate the last transmission (RVid=0) over the maximum bandwidth of 17 RBGs, frequency wrap-around is used.

In many implementations, the WTRU may inform the network of its capability or support for frequency bundled transmissions. The network may optionally enable or disable this feature for the WTRU based on the WTRU capability and network's requirement. The WTRU may inform the network of its capability via an information message, which may include a parameter “FBTSupport”, indicating whether the WTRU may support frequency bundled transmission. The parameter may be set as a flag, predetermined bit, or any other string. The parameter may be sent on a per-WTRU basis, and may also indicate frequency and/or time domain capability as well as available frequency ranges.

In implementations of frequency bundled transmissions with frequency domain repetitions, bundles of UL data retransmissions (e.g., {RVid=2, RVid=3, RVid=1, RVid=0}) may transmitted in frequency domain across multiple frequency resources as illustrated in FIG. 3E. The figure shows a PDCCH occasion where DCI 0_0 or DCI 0_1 schedules UL data after K2 offset. After the allocated offset, frequency bundled transmissions with frequency domain repetitions are transmitted simultaneously over different frequency resources and separated by J2 RBGs.

FIG. 3E shows an example of UL data transmitted using FBT with frequency domain repetitions and slot aggregation over 4 consecutive mini slots. In each transmission instance, a bundle of 4 transmissions is transmitted over 4 consecutive RBGs and simultaneously repeated after 4 RBGs. Transmissions in each transmission instance are shifted by one symbol in the time domain and by one RBG in the frequency domain.

Frequency domain repetitions can also be paired with PUSCH slot aggregation in some implementations, and a frequency shift can be applied between simultaneous transmissions as shown in FIG. 3F, which illustrates another example of frequency bundled transmissions with frequency domain repetitions and a frequency shift.

The network configures frequency bundled transmission with frequency domain repetitions via RRC signaling the same way it configures frequency bundled transmission. Similar to FBT, the network may transmit the following via RRC signaling:
pusch-FrequencyBundlingFactor within PUSCH-Config IE is used for the case of dynamic scheduling and is defined below
   pusch-FrequencyBundlingFactor ENUMERATED {n1, n2, n4, n8}
repJ within ConfiguredGrantConfig IE for the case of configured grant. This field is mandatorily present and takes values of 1, 2, 4, and 8. Frequency bundling is activated when repJ>1.
   repJ ENUMERATED {n1, n2, n4, n8}
numOfBundles This parameter indicates the number of bundles transmitted simultaneously
   numOfBundles ENUMERATED {n1, n2, n4, n8}
timeShiftSymbols: this is used to indicate the time shift in symbols between the first transmission and subsequent retransmissions (after K2 slots). This time shift may not apply if the system cannot support it.
   timeShiftSymbols{n0, n1,n2,n12}, where n0 means no time shift is applied (ex, URLLC applications)

For systems operating in TDD mode, a conflict between scheduling UL symbols are the slot format may not happen as both timeShiftSymbols and TDD-UL-DL-ConfigCommon (which dedtermines the slot format) are part of RRC signaling. Additional parameters include:
freqShiftRBGs: this is used to indicate the frequency shift in RBGs between the same transmission but different time instances. This frequency shift may not apply if the system cannot support it.
   freqShiftRBGs {n0, n1, . . . , n16}, where n0 means no frequency shift is applied.
FreqGap: this defines the separation in frequency between simultaneous HARQ bundles. A maximum value may be predetermined or specified in some implementations;

In PDCCH (DCI) for uplink scheduling, the following parameter is received:
J2: similar to FBT, this parameter indicates the offset between simultaneous UL transmissions in unit of RBs. This offset may be configured larger than the bandwidth of the interferer to minimize the probability of erroneous reception. Since config #1 minimum rbg-Size is 2 RBs and config #2 minimum rbg-Size is 4 RBs and the largest possible carrier bandwidth is limited to 275 RBs for any SCS, J2 can be defined as follows:
   J2 ENUMERATED {n0, n1, . . . , n136}, where J0 indicates that the first retransmission of the first bundle occurs in the same RBG as the scheduling DCI.

In some implementations, the WTRU may inform the network of its frequency bundled transmissions with frequency domain repetitions supportability. The network may optionally enable or disable this feature for the WTRU based on the WTRU capability and network's requirement. The WTRU may inform the network of its capability via an information message, which may include a parameter “FBTwithFreqRepSupport”, indicating whether the WTRU may support frequency bundled transmission. The parameter may be set as a flag, predetermined bit, or any other string. The parameter may be sent on a per-WTRU basis, and may also indicate frequency and/or time domain capability as well as available frequency ranges.

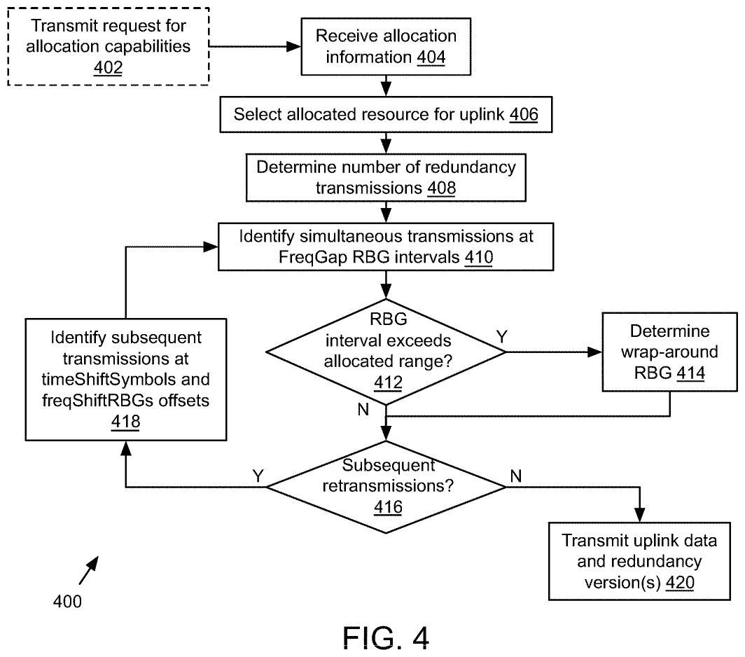

FIG. 4 is a flow chart of a method 400 for frequency bundled transmissions, according to some implementations. In some implementations at 402, a device, such as a WTRU, station (STA), user equipment (UE), wireless device, portable computer, smartphone, or other device may transmit a request for allocation capabilities to a second device, such as another WTRU, an access point (AP), a peer wireless device, a portable computing device, or any other type and form of wireless device. The request may comprise a request for whether the other device can use one or more of slot aggregation, frequency aggregation, frequency bundled transmissions, frequency domain repetitions, and/or time domain repetitions. In other implementations, 402 may be skipped and the other device may broadcast its capabilities periodically, responsive to the first device joining a network, etc.

At 404, the first device may receive time and/or frequency allocation information in some implementations. This may be responsive to the request at 402, or transmitted periodically or dynamically in response to any other type and form of request or trigger. The time and/or frequency allocation information may include transmission configuration parameters, such as offsets of uplink transmissions in terms of resource blocks and/or mini slot offsets (e.g. J2, K2 parameters); start symbol and/or length (S and L parameters); mapping type parameters; number of repetitions or redundancy transmissions; time shifts in number of symbols; frequency shifts in resource block groups; frequency gaps or intervals in resource block groups; and/or any other type and form of information or parameters for data transmissions and/or retransmissions or redundancy transmissions.

At 406, in some embodiments, the first device may select an allocated resource for the data transmission (e.g. a slot or symbols and a resource block group or groups). In some implementations, the first device may select a plurality of resource blocks for the transmission (e.g. for frequency bundled transmissions that exceed the bandwidth of a single resource block group).

At 408, in some embodiments, the first device may determine a number of redundancy transmissions to perform based on the received allocation information (e.g. one retransmission, two retransmissions, four retransmissions, etc.).

At 410, in some embodiments where a number of frequency bundled transmissions are to be performed, the first device may determine how separated the transmissions to be or what frequency gaps should be included between transmission portions. For example, in some implementations as shown in FIG. 3E above, a frequency bundled transmission may include a plurality of consecutive frequency ranges or resource block groups. In other implementations as shown in FIG. 3A, the frequency bundled transmission may have portions separated by a predetermined number of resource block groups (e.g. 3 groups), which may correspond to consecutive frequency ranges (e.g. 10 MHz, 20 MHz, 40 MHz, etc.).

As discussed above, in some implementations, separating a frequency bundled transmission with intervening intervals may cause one or more of the transmission segments to exceed an allocation range, as shown in 3D. At 412, the first device may determine whether the frequency intervals and number of segments or portions (as well as the starting resource block group) will cause one or more resource blocks to exceed the end of the allocated range. If so, at 414, the first device may determine alternate resource blocks for the one or more segments that “wrap around” the frequency range—that is, if a block at a predetermined interval would exceed the range by n resource blocks, the first device may identify a block that is n resource blocks above the bottom of the range. In other words, the first device may select a transmission frequency within the predetermined range such that a difference between the originally determined transmission frequency of a redundancy version and one end of the predetermined range which it exceeds is equal to a difference between the selected transmission frequency and an opposing end of the predetermined range.

At 416, the first device may determine whether there are additional segments or retransmissions or redundancy transmissions not yet scheduled. If so, at 418, the first device may identify the start of a subsequent transmission based on a time shift in symbols and/or a frequency shift in resource block groups according to the received allocation information. The first device may then repeat 410-418 for each additional retransmission or redundancy transmission (as well as for frequency bundled segments or portions of the redundancy transmissions).

At 420, the first device may transmit the uplink data and redundancy transmissions according to the selected or scheduled slots and resource block groups. As discussed above, scheduling the transmissions with time and/or frequency diversity may help to avoid interference, such as from airport or weather radars or other transmitting devices within the same allocated frequency region.

Accordingly, in a first aspect, the present disclosure is directed to a device, such as a WTRU, configured to receive information determining allocated frequency and time resources for uplink data transmissions. In some implementations, based on the received information, the device may transmit individual HARQ redundancy versions of the same data simultaneously over different frequency resources. In a further implementation, the Frequency Bundled Transmission (FBT) technique may be combined with PUSCH slot aggregation to increase the probability of correct data decoding. Transmission of individual redundancy versions may allow for more reliable data transmission while maintaining maximum user capacity in the system. Multiple mini slots can be transmitted simultaneously over different frequency resources, supporting delay sensitive applications in URLLC systems. In some implementations, the gNB may determine K2 and J2 parameters based on prior knowledge of interference patterns. In various implementations, uplink retransmission may occur in non-adaptive or adaptive mode (for example, in an adaptive mode implementation, retransmission parameters such as MCS may be changed according to the channel conditions, e.g., level of Radar interference at the gNB). In some implementations, FBT may be configured with dynamic scheduling or semi-persistence scheduling and with frequency resource allocation type 0, type 1 or type 2.

In another aspect, the present disclosure is directed to a device, such as a WTRU, configured to receive information determining allocated frequency and time resources for uplink data transmissions. Based on the received information, the device may transmit bundles of HARQ redundancy versions of the same data simultaneously over different frequency resources. In some implementations, the Frequency Bundled Transmission (FBT) technique may be repeated in the time domain with some pre-determined frequency shift to increase the probability of correct data decoding. Transmission of bundles of redundancy versions allows for a more reliable data transmission (compared to FBT) but may reduce user capacity in the system, in some implementations. Multiple mini slots can be transmitted simultaneously over different frequency resources, supporting delay sensitive applications in URLLC systems. In some implementations, the gNB may determine K2 and J2 parameters based on prior knowledge of interference patterns. Uplink retransmission may occur in non-adaptive or adaptive mode (for example, in an adaptive mode implementation, retransmission parameters such as MCS may be changed according to the channel conditions, e.g., level of Radar interference at the gNB). In some implementations, FBT with frequency domain repetitions may be configured with dynamic scheduling or semi-persistence scheduling and with frequency resource allocation type 0, type 1 or type 2.

In some aspects, the present disclosure is directed to a method for frequency bundled transmissions of redundancy versions of data. The method includes receiving, by a wireless device, information identifying allocated frequency resources and time resources for uplink data transmissions. The method also includes transmitting, by the wireless device, uplink data via a first allocated frequency resource and first allocated time resource. The method also includes transmitting, by the wireless device, at least one redundancy version of the uplink data via additional allocated frequency resources and time resources.

In some embodiments, the information identifying allocated frequency and time resources comprises information identifying a time separation between the transmission of the uplink data and the transmission of the at least one redundancy version of the uplink data. In some embodiments, the information identifying allocated frequency and time resources comprises information identifying a frequency separation between the transmission of the uplink data and the transmission of the at least one redundancy version of the uplink data. In a further embodiment, transmitting at least one redundancy version of the uplink data further comprises determining, by the wireless device, that the frequency separation indicates a first transmission frequency of a redundancy version exceeds a predetermined range. In a still further embodiment, the method includes, responsive to the determination, selecting, by the wireless device, a second transmission frequency within the predetermined range such that a difference between the first transmission frequency of a redundancy version and one end of the predetermined range which it exceeds is equal to a difference between the second transmission frequency and an opposing end of the predetermined range.

In some embodiments, the information identifying allocated frequency and time resources is transmitted by a second wireless device responsive to receipt of a transmission, by the wireless device, comprising information indicating a frequency bundled transmission capability of the wireless device.

In some embodiments, the transmission of a first redundancy version of the at least one redundancy versions of the uplink data is performed simultaneously with the transmission of the uplink data. In a further embodiment, the transmission of the uplink data is performed on a first resource block group of the allocated frequency resources, and the transmission of the first redundancy version is performed on a second, adjacent resource block group of the allocated frequency resources. In another further embodiment, the transmission of the uplink data is performed on a first resource block group of the allocated frequency resources, and the transmission of the first redundancy version is performed on a second, non-adjacent resource block group of the allocated frequency resources.

In some embodiments, the transmission of a second redundancy version of the at least one redundancy versions of the uplink data is performed at a subsequent time and on a resource block group of the allocated frequency resources different from a resource block group used for the transmission of the uplink data.

In another aspect, the present disclosure is directed to a wireless transmit/receive unit (WTRU). The WTRU includes one or more receivers configured to receive information identifying allocated frequency resources and time resources for uplink data transmissions. The WTRU also includes one or more transmitters configured to: transmit uplink data via a first allocated frequency resource and first allocated time resource; and transmit at least one redundancy version of the uplink data via additional allocated frequency resources and time resources.

In some embodiments, the information identifying allocated frequency and time resources comprises information identifying a time separation between the transmission of the uplink data and the transmission of the at least one redundancy version of the uplink data. In some embodiments, the information identifying allocated frequency and time resources comprises information identifying a frequency separation between the transmission of the uplink data and the transmission of the at least one redundancy version of the uplink data. In a further embodiment, the WTRU includes one or more processors configured to determine that the frequency separation indicates a first transmission frequency of a redundancy version exceeds a predetermined range. In a still further embodiment, the one or more processors are further configured to select a second transmission frequency within the predetermined range such that a difference between the first transmission frequency of a redundancy version and one end of the predetermined range which it exceeds is equal to a difference between the second transmission frequency and an opposing end of the predetermined range.

In some embodiments, the information identifying allocated frequency and time resources is transmitted by a remote wireless device responsive to receipt of a transmission, by the remote wireless device, comprising information indicating a frequency bundled transmission capability of the remote wireless device.

In some embodiments, the transmission of a first redundancy version of the at least one redundancy versions of the uplink data is performed simultaneously with the transmission of the uplink data. In a further embodiment, the transmission of the uplink data is performed on a first resource block group of the allocated frequency resources, and the transmission of the first redundancy version is performed on a second, adjacent resource block group of the allocated frequency resources. In another further embodiment, the transmission of the uplink data is performed on a first resource block group of the allocated frequency resources, and the transmission of the first redundancy version is performed on a second, non-adjacent resource block group of the allocated frequency resources.

In some embodiments, the transmission of a second redundancy version of the at least one redundancy versions of the uplink data is performed at a subsequent time and on a resource block group of the allocated frequency resources different from a resource block group used for the transmission of the uplink data.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for frequency bundled transmissions of redundancy versions of data, comprising:
receiving, by a wireless device, information identifying allocated frequency resources and time resources for uplink data transmissions;
transmitting, by the wireless device, uplink data via a first allocated frequency resource and first allocated time resource; and
transmitting, by the wireless device, at least one redundancy version of the uplink data via additional allocated frequency resources and time resources.

2. The method of claim 1, wherein the information identifying allocated frequency resources and time resources comprises information identifying a time separation between the transmitting the uplink data and the transmitting the at least one redundancy version of the uplink data.

3. The method of claim 1, wherein the information identifying allocated frequency resources and time resources comprises information identifying a frequency separation between the transmitting the uplink data and the transmitting the at least one redundancy version of the uplink data.

4. The method of claim 3, wherein transmitting at least one redundancy version of the uplink data further comprises determining, by the wireless device, that the frequency separation indicates a first transmission frequency of a redundancy version exceeds a predetermined range.

5. The method of claim 4, further comprising, responsive to the determining that the frequency separation indicates a first transmission frequency of a redundancy version exceeds a predetermined range, selecting, by the wireless device, a second transmission frequency within the predetermined range such that a difference between the first transmission frequency of a redundancy version and one end of the predetermined range which it exceeds is equal to a difference between the second transmission frequency and an opposing end of the predetermined range.

6. The method of claim 1, wherein the information identifying allocated frequency resources and time resources is received from a second wireless device responsive to a transmission, by the wireless device, comprising information indicating a frequency bundled transmission capability of the wireless device.

7. The method of claim 1, wherein transmitting a first redundancy version of the at least one redundancy version of the uplink data is performed simultaneously with the transmitting the uplink data.

8. The method of claim 7, wherein the transmitting the uplink data is performed on a first resource block group of the allocated frequency resources, and the transmitting the first redundancy version is performed on a second, adjacent resource block group of the allocated frequency resources.

9. The method of claim 7, wherein the transmitting the uplink data is performed on a first resource block group of the allocated frequency resources, and the transmitting the first redundancy version is performed on a second, non-adjacent resource block group of the allocated frequency resources.

10. The method of claim 1, wherein transmitting a second redundancy version of the at least one redundancy version of the uplink data is performed at a subsequent time and on a resource block group of the allocated frequency resources different from a resource block group used for the transmitting the uplink data.

11. A wireless transmit/receive unit (WTRU)comprising:
a receiver;
a transmitter; and
a processor, wherein:
the receiver and the processor are configured to receive information identifying allocated frequency resources and time resources for uplink data transmissions;
the transmitter and the processor are configured to transmit uplink data via a first allocated frequency resource and first allocated time resource; and
the transmitter and the processor are further configured to transmit at least one redundancy version of the uplink data via additional allocated frequency resources and time resources.

12. The WTRU of claim 11, wherein the information identifying allocated frequency resources and time resources comprises information identifying a time separation between the transmission of the uplink data and the transmission of the at least one redundancy version of the uplink data.

13. The WTRU of claim 11, wherein the information identifying allocated frequency resources and time resources comprises information identifying a frequency separation between the transmission of the uplink data and the transmission of the at least one redundancy version of the uplink data.

14. The WTRU of claim 13, wherein the processor is further configured to determine that the frequency separation indicates a first transmission frequency of a redundancy version exceeds a predetermined range.

15. The WTRU of claim 14, wherein the processor is further configured to select a second transmission frequency within the predetermined range such that a difference between the first transmission frequency of a redundancy version and one end of the predetermined range which it exceeds is equal to a difference between the second transmission frequency and an opposing end of the predetermined range.

16. The WTRU of claim 11, wherein the information identifying allocated frequency resources and time resources is received from a second WTRU responsive to a transmission, by the WTRU, comprising information indicating a frequency bundled transmission capability of the WTRU.

17. The WTRU of claim 11, wherein a transmission of a first redundancy version of the at least one redundancy version of the uplink data is performed simultaneously with the transmission of the uplink data.

18. The WTRU of claim 17, wherein the transmission of the uplink data is performed on a first resource block group of the allocated frequency resources, and the transmission of the first redundancy version is performed on a second, adjacent resource block group of the allocated frequency resources.

19. The WTRU of claim 17, wherein the transmission of the uplink data is performed on a first resource block group of the allocated frequency resources, and the transmission of the first redundancy version is performed on a second, non-adjacent resource block group of the allocated frequency resources.

20. The WTRU of claim 11, wherein a transmission of a second redundancy version of the at least one redundancy version of the uplink data is performed at a subsequent time and on a resource block group of the allocated frequency resources different from a resource block group used for the transmission of the uplink data.
